(19) United States
(12) Patent Application Publication
(10) Pub. No.: US 2023/0006455 A1
(43) Pub. Date: Jan. 5, 2023

(54) CONTROL DEVICE AND CHARGING SYSTEM

(71) Applicant: SEIKO EPSON CORPORATION, Tokyo (JP)

(72) Inventor: Kinya Matsuda, Matsumoto-shi (JP)

(21) Appl. No.: 17/851,460

(22) Filed: Jun. 28, 2022

(30) Foreign Application Priority Data
Jun. 30, 2021 (JP) 2021-108711

(51) Int. Cl. H02J 7/00; H02J 7/24

(52) U.S. Cl. CPC H02J 7/00034; H02J 7/007182; H02J 7/0048; H02J 7/2434

(57) ABSTRACT

A control device includes a communication circuit configured to acquire battery voltage information of a battery of an electronic device, and a control circuit configured to control, based on the battery voltage information, a charging voltage supply circuit that supplies a charging voltage to the electronic device at a contact point such that a voltage difference between the charging voltage and a battery voltage of the battery is a given set voltage.

The present application is based on, and claims priority from JP Application Serial Number 2021-108711, filed Jun. 30, 2021, the disclosure of which is hereby incorporated by reference herein in its entirety.

### BACKGROUND

### 1. Technical Field

The present disclosure relates to a control device and a charging system.

### 2. Related Art

JP-A-2009-089523 discloses a method for calculating a voltage difference between a battery voltage and a target voltage set in advance, and controlling output of a charger according to the voltage difference. The control is performed by increasing the output from the charger as the voltage difference between the target voltage and the battery voltage increases.

In the control method disclosed in JP-A-2009-089523, when the battery voltage is low, the voltage difference between the battery voltage and the charging voltage increases. In this case, since a charging voltage equal to or higher than a minimum voltage necessary for securing a constant current in charging is supplied, a problem associated with an increase in temperature of the electronic device occurs.

### SUMMARY

An aspect of the present disclosure relates to a control device including a communication circuit configured to acquire battery voltage information of a battery of an electronic device, and a control circuit configured to control, based on the battery voltage information, a charging voltage supply circuit that supplies a charging voltage to the electronic device at a contact point such that a voltage difference between the charging voltage and a battery voltage of the battery is a given set voltage.

Another aspect of the present disclosure relates to a contact type charging system including an electronic device and a charger. The electronic device is configured to transmit battery voltage information of a battery of the electronic device to the charger, and the charger is configured to output a charging voltage of the battery based on the battery voltage information such that a voltage difference between the charging voltage and a battery voltage of the battery is a given set voltage.

Yet another aspect of the present disclosure relates to a control device including a charging circuit configured to charge a battery based on a charging voltage supplied from a charger at a contact point, a communication circuit configured to transmit a battery voltage of the battery to the charger, and a control circuit configured to control the communication circuit and the charging circuit. The control circuit is configured to monitor a voltage difference between the charging voltage and the battery voltage or the battery voltage, and determine a transmission timing of battery voltage information based on a monitoring result.

### BRIEF DESCRIPTION OF THE DRAWINGS

FIG. 1 is a configuration example of a control device and a charging system according to the present embodiment.

FIG. 2 is a signal waveform diagram of a battery voltage, a charging voltage, and a charging current.

FIG. 3 is a detailed configuration example of the control device and the charging system according to the present embodiment.

FIG. 4 is a configuration example of a communication circuit of a charger.

FIG. 5 is a diagram illustrating a data processing method in a comparison circuit.

FIG. 6 is a configuration example of a charging circuit.

FIG. 7 is a configuration example of a communication circuit of an electronic device.

FIG. 8 is another configuration example of the communication circuit of the electronic device.

FIG. 9 is a diagram illustrating waveform patterns used in a communication method according to the present embodiment.

FIG. 10 is a diagram illustrating a correspondence relationship between a waveform pattern of a communication signal and a logic level.

FIG. 11 is a modification of the control device and the charging system.

FIG. 12 is a modification of the control device and the charging system.

FIG. 13 is a flowchart illustrating a communication process according to the present embodiment.

FIG. 14 is a flowchart illustrating a detailed example of the communication process according to the embodiment.

FIG. 15 is a flowchart illustrating a detailed example of the communication process according to the present embodiment.

FIG. 16 is a flowchart illustrating a detailed example of the communication process according to the present embodiment.

### DESCRIPTION OF EXEMPLARY EMBODIMENTS

Hereinafter, the present embodiment will be described. The present embodiment described below does not unduly limit contents of the claims. Moreover, not all of the configurations described in the present embodiment are essential constituent elements.

### 1. Control Device and Charging System

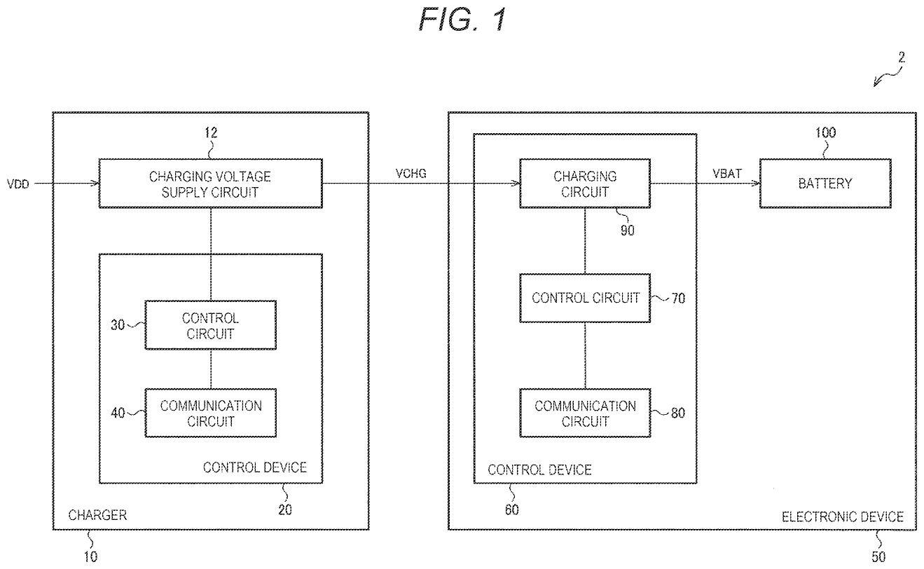

FIG. 1 shows a configuration example of a control device 20 and a charging system 2 according to the present embodiment. The charging system 2 includes a charger 10 and an electronic device 50. The control device 20 according to the present embodiment is provided in the charger 10 of the charging system 2.

The electronic device 50 includes a control device 60 and a battery 100. Various devices can be assumed as the electronic device 50 to which the present embodiment is applied. For example, electronic devices such as a hearing aid, a wristwatch, a wearable device, a biological information measuring device, a smart phone, a portable information terminal such as a mobile phone, a cordless phone, a shaver, an electric toothbrush, a wrist computer, a handy terminal, an electric vehicle, and an electric bicycle can be assumed.

The battery 100 is, for example, a rechargeable secondary battery, and is, for example, a lithium battery such as a lithium ion secondary battery or a lithium ion polymer secondary battery, or a nickel battery such as a nickel-hydrogen storage battery or a nickel-cadmium storage battery.

The control device 60 of the electronic device 50 includes a control circuit 70, a communication circuit 80, and a charging circuit 90. The control device 60 can be implemented by, for example, an integrated circuit device called an integrated circuit (IC).

The control circuit 70 executes a control process of each circuit of the electronic device 50. For example, the control circuit 70 controls the communication circuit 80 and the charging circuit 90. The control circuit 70 can be implemented by, for example, a logic circuit generated by an automatic placement-routing method such as a gate array, or various processors such as a microcomputer.

The communication circuit 80 is a circuit for performing communication between the charger 10 and the electronic device 50. Specifically, the communication circuit 80 transmits communication data including battery voltage information of the electronic device 50 to a communication circuit 40 of the charger 10. The battery voltage information is, for example, information on a battery voltage VBAT, and may be voltage difference information between a battery voltage and a charging voltage, that is, information on a voltage difference between the battery voltage VBAT and a charging voltage VCHG. Here, the battery voltage VBAT is a voltage of the battery 100 as shown in FIG. 1. The battery voltage VBAT is, for example, in a range of about 3.2 V to 4.2 V in a case of a lithium ion battery. The charging voltage VCHG is a voltage output from a charging voltage supply circuit 12. In addition, the battery voltage information may include information on a temperature, a charging voltage, a charging status flag, the number of charging cycles, an IC number, and the like.

The charging circuit 90 charges the battery 100. That is, the charging circuit 90 charges the battery 100 based on the charging voltage VCHG from the charger 10. Specifically, the charging circuit 90 charges the battery 100 by, for example, constant-current (CC) charging based on the charging voltage VCHG from the charger 10. In addition, although the charging circuit 90 is provided in the control device 80 which is an IC in FIG. 1, a modification in which the charging circuit 90 is provided outside the control device 80 can also be implemented.

The charger 10 includes the charging voltage supply circuit 12 and the control device 20. As shown in FIG. 1, the charger 10 transmits electric power, which is supplied from a power supply via a power supply line, to the electronic device 50 side by a contact point via the charging voltage supply circuit 12. It can be assumed that the transmission of the electric power by the contact point is in various modes, such as a mode in which the charger 10 and a metal terminal of the electronic device 50 are electrically coupled with each other by contact, or a mode in which the charger 10 and a metal terminal of the electronic device 50 are electrically coupled with each other via a wiring cable or the like. The power supply is a power supply on a high voltage side, and is, for example, a power supply voltage VDD. The power supply may be a power supply by USB or a power supply by a mobile battery provided in the charger 10. The power supply voltage VDD is, for example, 5 V.

The charging voltage supply circuit 12 outputs, as the charging voltage VCHG, a voltage obtained by, for example, lowering the power supply voltage VDD. Alternatively, the charging voltage supply circuit 12 may output a voltage obtained by boosting the power supply voltage VDD. Specifically, based on a control signal from a control circuit 30, the charging voltage supply circuit 12 outputs, as the charging voltage VCHG, a voltage obtained by boosting or lowering the power supply voltage VDD. That is, the charging voltage supply circuit 12 outputs the charging voltage VCHG whose voltage is variably controlled by the control circuit 30. Then, when the charging voltage supply circuit 12 outputs the charging voltage VCHG, the electric power is supplied from the charger 10 to the electronic device 50, and the battery 100 is charged with the electric power. The charging voltage supply circuit 12 can be implemented by, for example, a DC-DC converter. Specifically, the charging voltage supply circuit 12 is implemented by a DC-DC converter including a switching regulator or the like.

The control device 20 of the charger 10 includes the control circuit 30 and the communication circuit 40. The control device 20 can be implemented by, for example, an integrated circuit device called an IC. A modification in which the charging voltage supply circuit 12 is provided in the control device 20 which is an IC can also be implemented.

The communication circuit 40 is a circuit for performing communication between the charger 10 and the electronic device 50. Specifically, the communication circuit 40 receives communication data including battery voltage information transmitted from the communication circuit 80 of the electronic device 50. The control circuit performs various processes based on the received communication data. Specifically, the control circuit 30 controls, based on the received communication data, the charging voltage supply circuit 12 to perform a process of setting the charging voltage VCHG. The battery voltage information is as described above.

The control circuit 30 executes various control processes of the control device 20 in the charger 10. For example, the control circuit 30 controls the charging voltage supply circuit 12. Specifically, the control circuit 30 performs various sequence control and determination processes necessary for electric power transmission, a communication process, and the like. The control circuit 30 can be implemented by, for example, a logic circuit generated by an automatic placement-routing method such as a gate array, or various processors such as a microcomputer.

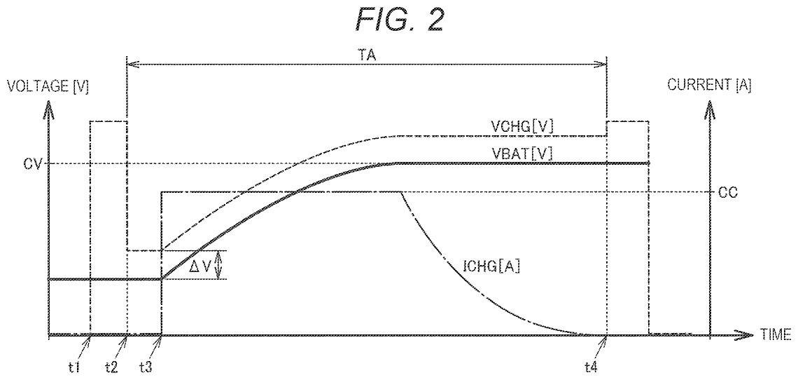

FIG. 2 is a diagram illustrating a time dependence of the battery voltage VBAT, the charging voltage VCHG, and a charging current ICHG when the battery 100 is charged by the CC charging in the charging system 2. In a horizontal axis in FIG. 2, t1 indicates a timing at which the electronic device 50 is placed on the charger 10, t2 indicates a timing at which the charger 10 starts communication of information of the battery voltage VBAT, t3 indicates a timing at which the charging is started, and t4 indicates a timing at which the charging is ended. A vertical axis on a left side in FIG. 2 corresponds to the battery voltage VBAT and the charging voltage VCHG, and a vertical axis on a right side corresponds to the charging current ICHG. In addition, a solid line indicates the battery voltage VBAT, a dotted line indicates the charging voltage VCHG, and a dotted and dashed line indicates the charging current ICHG. First, when the electronic device 50 is placed on the charger 10 at the timing t1, the charging voltage VCHG is boosted to a predetermined voltage under the control of the control circuit 30. Next, when the charger 10 receives the battery voltage information from the electronic device 50 at the timing t2, the charging voltage VCHG is boosted to a minimum charging voltage (VBAT+ΔV) necessary for securing a constant current CC in the CC charging. Thereafter, when the charging is started at the timing t3, the charging current ICHG having a current value of CC flows. Then, during a period TA until the charging is ended, the control is performed such that the charging voltage VCHG is VBAT+ΔV according to the battery voltage VBAT sequentially transmitted from the electronic device 50. When the battery 100 approaches full charge in the middle of the period TA, the charging current ICHG gradually decreases and approaches zero. Then, when the charging current ICHG is zero at the timing t4, the charging is ended.

As described above, the charging of the battery 100 in the electronic device 50 is performed by, for example, the constant-current (CC) charging. Therefore, in order to secure the constant current for charging, it is necessary to control the magnitude of the charging voltage VCHG such that VCHG>VBAT. On the other hand, when the charging voltage VCHG exceeds the minimum voltage (VBAT+ΔV) necessary for securing the constant current for charging, heat corresponding to a surplus of the charging voltage VCHG (VCHG−(VBAT+ΔV)) is generated in the electronic device 50. When the internal temperature of the electronic device increases due to the heat, operations of the control device 60 is adversely affected and reliability of a circuit operation is degraded. In addition, when the temperature of the electronic device 50 exceeds a predetermined temperature, a problem such as a stop of a charging operation of the electronic device 50 may occur.

In this regard, according to the present embodiment, the control circuit 30 controls the charging voltage supply circuit 12 based on, for example, the information on the battery voltage VBAT received from the communication circuit 80 such that the voltage difference between the charging voltage VCHG and the battery voltage VBAT is a given set voltage ΔV. That is, as shown in FIG. 2, in the period TA, the charging voltage VCHG is controlled such that the voltage difference between the charging voltage VCHG and the battery voltage VBAT is the given set voltage ΔV. The given set voltage ΔV can be determined in consideration of an allowable amount of heat generation in the electronic device 50 and the like, and is, for example, about 0.4 V to 0.8 V, and preferably about 0.4 V to 0.6 V.

In the control device according to the present embodiment, when the battery voltage information is set to the battery voltage VBAT, the control circuit 30 can determine the minimum voltage necessary for securing the constant current for charging the battery 100, and the charging voltage supply circuit 12 can set the magnitude of the charging voltage VCHG to this voltage. This makes it possible to charge the battery 100 by the CC charging while avoiding the problem due to heat described above. In addition, when the battery voltage information is set to the voltage difference information between the battery voltage VBAT and the charging voltage VCHG, the control process of the charging voltage VCHG on the charger 10 side can be facilitated as compared with the case where the battery voltage information is set to the battery voltage VBAT. That is, when the voltage difference is smaller than the minimum set voltage ΔV necessary for securing the constant current for charging the battery 100, a process for changing the charging voltage VCHG output by the charging voltage supply circuit 12 may not be performed. When the charger 10 is a portable case driven by a mobile battery, consumption of the mobile battery can be reduced.

### 2. Detailed Configuration Examples

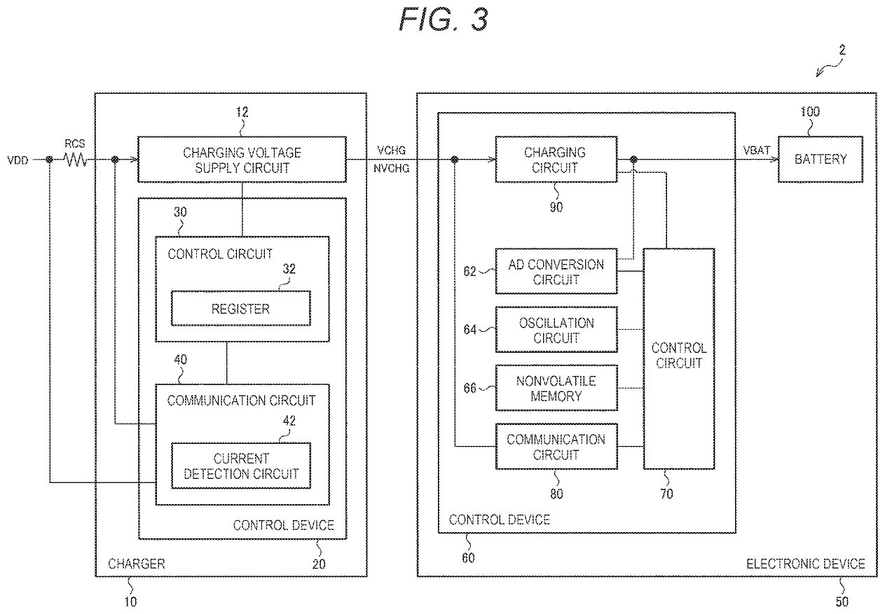

FIG. 3 shows a detailed configuration example of the control device 20 and the charging system 2. The detailed configuration example is a configuration example in which data communication between the charger 10 and the electronic device 50 is implemented by load modulation described below. The detailed configuration example is different from the configuration example in FIG. 1 in configurations of the control devices 20 and 60. The control device 60 on the electronic device 50 side includes an AD conversion circuit 62, an oscillation circuit 64, and a nonvolatile memory 66 in addition to components of the control device 60 in FIG. 1. In the control device 20 on the charger 10 side, the control circuit 30 includes a register 32, and the communication circuit 40 includes a current detection circuit 42.

The AD conversion circuit 62 performs A/D conversion on the battery voltage VBAT. Then, the AD conversion circuit 62 outputs, as a measurement result of the battery voltage VBAT, digital measurement data obtained by the A/D conversion on the battery voltage VBAT to the control circuit 70.

The oscillation circuit 64 generates a clock signal by oscillation, and outputs the clock signal to the control circuit 70. The control circuit 70 operates based on the clock signal from the oscillation circuit 64, and executes the control process. The oscillation circuit 64 is implemented by, for example, a crystal oscillation circuit.

The nonvolatile memory 66 is a nonvolatile storage device that stores various types of information. The control circuit 70 operates based on the information stored in the nonvolatile memory 66, or stores status information and the like into the nonvolatile memory 66. As the nonvolatile memory 66, for example, an EEPROM can be used. As the EEPROM, for example, a metal-oxide-nitride-oxide-silicon (MONOS) type memory can be used. For example, as the EEPROM, a flash memory using the MONOS type memory can be used. Alternatively, as the EEPROM, another type of memory such as a floating gate type may be used.

Another difference is that the communication circuit 80 of the electronic device 50 is electrically coupled to a supply node NVCHG of the charging voltage VCHG. The communication circuit 80 will be described in detail later.

The control circuit 30 of the control device 20 on the charger 10 side includes the register 32. The register 32 can be implemented by, for example, a flip-flop circuit or a memory such as a RAM. In the present embodiment, as described above, the control circuit 30 controls the charging voltage supply circuit 12 such that the voltage difference between the charging voltage VCHG and the battery voltage VBAT is a predetermined set voltage. The register 32 of the control circuit 30 is a register capable of setting the set voltage. That is, the register 32 stores information on a set voltage which is the voltage difference between the charging voltage VCHG and the battery voltage VBAT in the period TA in FIG. 2. For example, the information on the set voltage can be written to the register 32 by an external processing device. If such a register 32 is provided, the set voltage, which is the voltage difference between the charging voltage VCHG and the battery voltage VBAT, can be variably set to a desired voltage. Accordingly, it is possible to set in the register 32 the information on the set voltage according to an amount of heat generation allowed in the electronic device 50.

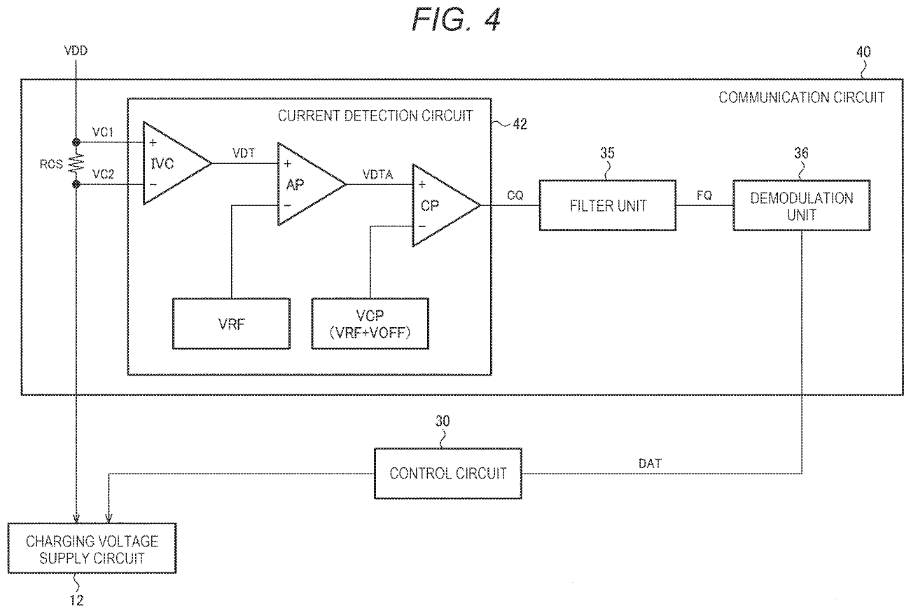

In addition, the communication circuit 40 on the charger 10 side in FIG. 3 includes the current detection circuit 42. FIG. 4 shows a detailed configuration example of the communication circuit 40. The current detection circuit 42 detects a current ID1 flowing through a power supply line of the charging voltage supply circuit 12. That is, the current detection circuit 42 detects the current ID1 flowing from a power supply having the VDD to the charging voltage supply circuit 12. The current detection circuit 42 includes an IV conversion amplifier IVC, an amplifier AP, and a comparison circuit CP.

In the IV conversion amplifier IVC, a non-inverting input terminal (+) is coupled to one end of a sense resistor RCS, and an inverting input terminal (−) is coupled to the other end of the sense resistor RCS. The IV conversion amplifier IVC amplifies a minute voltage (VC1−VC2) generated by a minute current ID1 flowing in the sense resistor RCS, and outputs the amplified voltage as a detection voltage VDT. The detection voltage VDT is further amplified by the amplifier AP and output to the comparison circuit CP as a detection voltage VDTA. Specifically, in the amplifier AP, a non-inverting input terminal receives the detection voltage VDT, an inverting input terminal receives a reference voltage VRF, and a signal of the detection voltage VDTA amplified based on the reference voltage VRF is output.

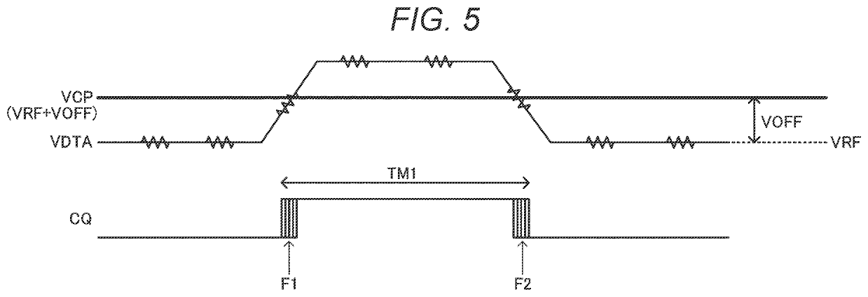

The comparison circuit CP performs a comparison determination between a determination voltage VCP and the detection voltage VDTA after voltage amplification by the IV conversion amplifier IVC, and outputs a comparison determination result CQ. FIG. 5 shows a relationship between the detection voltage VDTA and the determination voltage VCP. The determination voltage VCP is set to, for example, VRF+VOFF obtained by adding an offset voltage VOFF to the reference voltage VRF, and a comparison determination is performed as to determine whether the detection voltage VDTA is above or below the determination voltage VCP. When the detection voltage VDTA is above the determination voltage VCP, it is determined that a load state is a high load corresponding to bit=1 described above. The comparison circuit CP can be implemented by, for example, a comparator. In this case, for example, the offset voltage VOFF of the determination voltage VCP may be implemented by an offset voltage or the like of the comparator.

A filter unit 35 reduces noise included in the comparison determination result CQ. Specifically, adverse effects due to noise at a rising edge F1 and a falling edge F2 of a signal of the comparison determination result CQ in FIG. 5 can be reduced. The filter unit 35 is provided, for example, between the comparison circuit CP and a demodulation unit 36. For example, a digital filter such as an FIR may be used as the filter unit 35, and a passive filter may be used as the filter unit 35.

The demodulation unit 36 demodulates a load modulation pattern described later based on a comparison determination result FQ after the process with the filter unit 35. Specifically, the demodulation unit 36 detects a pulse in which the load state is a high load corresponding to bit=1, and performs bit synchronization when a width of the pulse is within a first range width of 220×T to 511×T, for example. For example, the demodulation unit 36 detects a first edge having a high load corresponding to bit=1 from a state where a signal of the comparison determination result FQ is a low load corresponding to bit=0 by a predetermined number of bits, and a second edge in which the comparison judgment result FQ changes from the high load to the low load after the first edge. When the width of the pulse defined by the first edge and the second edge is within the first width range, it is determined that bit synchronization has performed, and the first bit “1” of the communication data is detected. Then, when the bit synchronization is performed, a first sampling point SP1 is set at a center point of the pulse width, and a signal is captured every sampling interval SI from the first sampling point SP1. Next, if a level of the captured signal is at a level corresponding to the high load, a logic level is determined to be “1”, and if the level of the captured signal is at a level corresponding to the low load, the logic level is determined to be “0”. By performing a demodulation process of a load-modulated signal in this manner, the communication data is detected and output as detection data DAT to the control circuit 30.

According to the detailed configuration example shown in FIG. 3, in the charging system 2, the data communication between the charger 10 and the electronic device 50 can be implemented on a wiring used for electric power supply. Therefore, unlike a case of using serial communication described later, it is not necessary to provide a wiring separately from the wiring used for electric power supply. In addition, in communication by the load modulation, the logic level is made to correspond to a pattern waveform, the adverse effects due to noise of the signal and the like can be reduced.

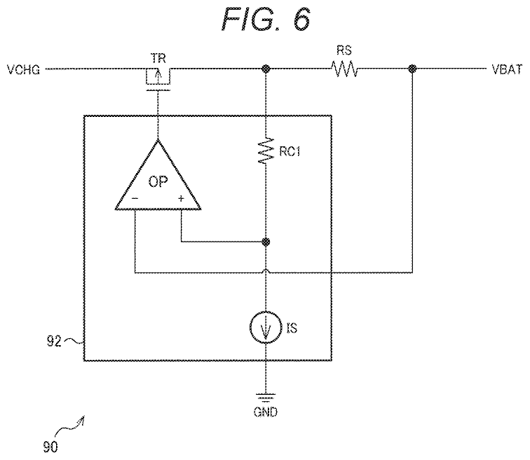

FIG. 6 shows a configuration example of the charging circuit 90. The charging circuit 90 includes a transistor TR, a resistor RS, and a current control circuit 92. The transistor TR and the resistor RS are provided in series between a supply node of the charging voltage VCHG and an output node of the battery voltage VBAT. The current control circuit 92 outputs an output signal to a gate terminal of the transistor TR and performs control of flowing a constant current through the resistor RS. Specifically, the current control circuit 92 includes an operational amplifier OP, a resistor RC1, and a current source IS. The transistor TR is controlled based on an output signal of the operational amplifier OP.

The transistor TR is controlled by virtual ground of the operational amplifier OP such that a voltage at a non-inverting input terminal, which is a voltage at one end of the resistor RC1, is equal to a voltage at an inverting input terminal, which is a voltage VCS2 at the other end of a sense resistor RS. For example, a current flowing through the current source IS is IDA, and a current flowing through the resistor RS is IRS. Then, the control is performed such that IRS×RS=IDA×RC1. That is, in the charging circuit 90, the current IRS, which is a charging current flowing through the sense resistor RS, is controlled to be a constant current value. Accordingly, the CC charging is possible. Then, for example, when the control circuit 70 controls the current IRS flowing through the current source IS, the current IRS, which is the charging current in the CC charging, can be variably controlled. In addition, ΔV in FIG. 2 is a voltage necessary for appropriately setting the transistor TR in an ON state and appropriately operating the charging circuit 90 in the charging circuit 90 in FIG. 6.

A voltage difference between one end and the other end of the resistor RS is VRS, and a drain-source voltage of the transistor TR is VDS. Then, a relational expression of VCHG−VBAT=VRS+VDS is established. In the present embodiment, as shown in FIG. 2, since the control is performed such that VCHG−VBAT=ΔV, a relationship of VCHG−VBAT=VRS+VDS=ΔV is established. Here, since the IRS which is a constant current flows through the resistor RS, VRS=IRS×RS is a constant voltage. Therefore, by setting ΔV which is a given set voltage such that the VDS which is the drain-source voltage of the transistor TR is a minimum necessary voltage for flowing the current IRS, heat generation in the transistor TR can be minimized. That is, in a method of a comparative example in which VCHG−VBAT=ΔV is not set, since VRS is a constant voltage as described above when the battery voltage VBAT is low, VDS which is the drain-source voltage of the transistor TR is high. Specifically, when the battery voltage VBAT is low, an ON resistance of the transistor TR whose gate voltage is controlled by the current control circuit 92 increases, whereby the VDS is high. Then, the electric power is consumed wastefully in the ON resistance, and a large amount of heat is generated in the transistor TR. In this regard, in the present embodiment, since ΔV which is a given set voltage is set such that the VDS is the minimum necessary voltage for flowing the current IRS, it is possible to reduce the heat generation caused by such wasteful electric power consumption.

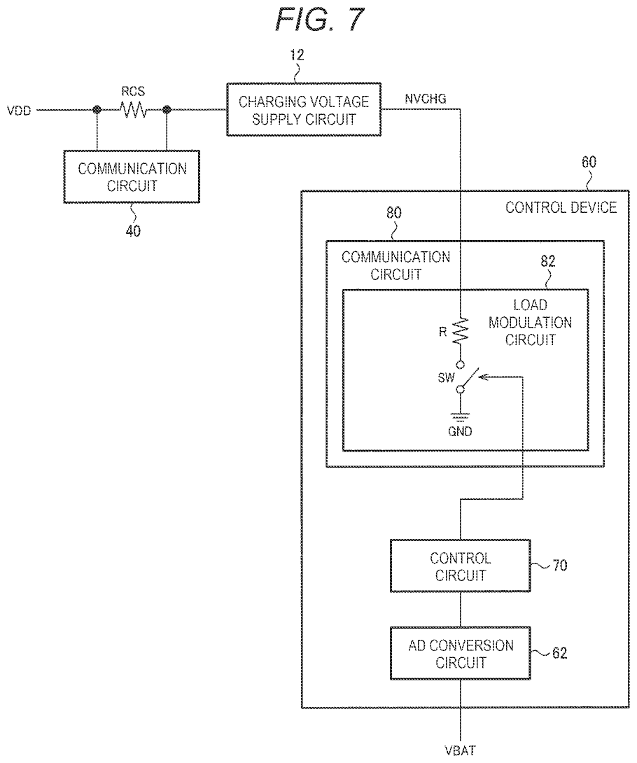

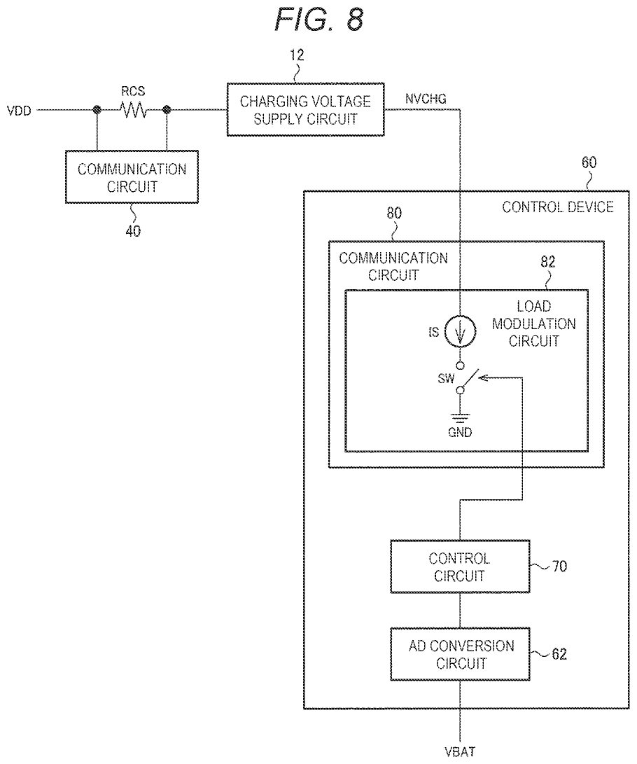

The communication circuit 80 in FIG. 3 will be described in detail. FIG. 7 is a configuration example of the communication circuit 80, and is a diagram showing a communication configuration when the data communication between the charger 10 and the electronic device 50 is performed by load modulation. The communication circuit 80 includes a load modulation circuit 82. The load modulation circuit 82 includes a resistor R and a switch element SW. The switch element SW can be implemented by a MOS transistor or the like. The resistor R and the switch element SW are provided in series between a supply node NVCHG and a ground node. An output signal of the control circuit 70 is input to the switch element SW. An arrangement order of the resistor R and the switch element SW may be reversed from that in FIG. 7, and the switch element SW may be provided on the supply node NVCHG side and the resistor R may be provided on the ground node side. In addition, the load modulation circuit 82 is not limited to the configuration shown in FIG. 7, and, for example, as shown in FIG. 8, the current source IS may be provided as an element corresponding to the resistor R in FIG. 7.

A method for transmitting data inside the electronic device 50 will be specifically described. The control circuit 70, which has acquired information on the measurement data of the battery voltage VBAT from the AD conversion circuit 62, controls the communication circuit based on the information. Specifically, the switch element SW is turned on or off based on the signal from the control circuit 70, and a current flowing from the supply node NVCHG to GND is turned on or off. Accordingly, data transmission of the battery voltage information by the load modulation is performed. The load modulation is performed by changing the load state from a first load state to a second load state. The first load state is, for example, a high load state, and the second state is, for example, a low load state. The first load state is a state where the switch element SW is turned on, and corresponds to bit=1. The second load state is a state where the switch element SW is turned off, and corresponds to bit=0.

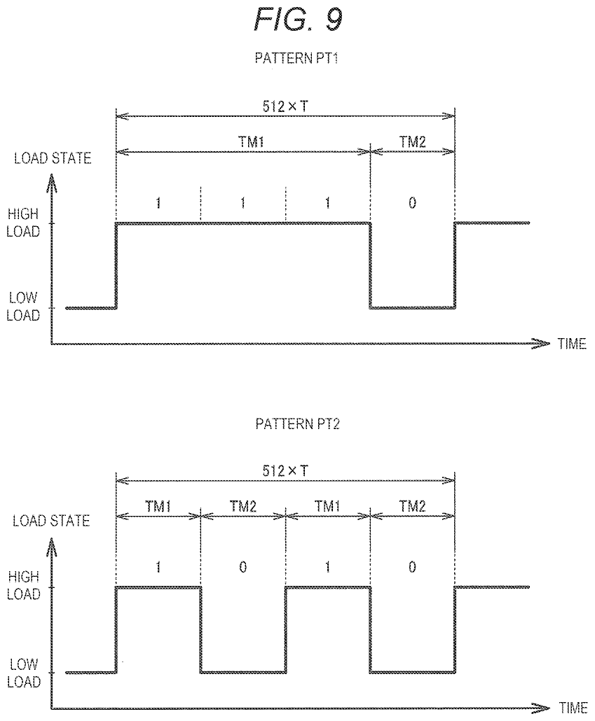

FIG. 9 shows waveform patterns used for the communication by the load modulation. A first pattern PT1 shown in an upper part is a pattern in which a width of a period TM1 in the first load state is longer than a width of a period TM2 in the second load state, and corresponds to the logic level “1”. On the other hand, a second pattern PT2 shown in a lower part of FIG. 9 is a pattern in which the width of the period TM1 in the first load state is equal to the width of the period TM2 in the second load state, and corresponds to the logic level “0”. Here, when a drive frequency of the oscillation circuit 64 is FCK and a drive cycle is T=1/FCK, a length of each pattern can be expressed as 512×T, for example. In this case, a length of one bit section is expressed as (512×T)/4=128×T. Therefore, when the load modulation circuit 82 transmits communication data whose logic level is “1”, the switch element SW is turned on or off by a bit pattern (1110) corresponding to the first pattern PT1 at an interval of, for example, 128×T. In addition, when the load modulation circuit 82 transmits the communication data whose logic level is “1”, the switch element SW is turned on or off by a bit pattern (1010) corresponding to the second pattern PT2 at an interval of, for example, 128×T. In this case, a length of the period TM1 of the first pattern PT1 and a length of the period TM1 of the second pattern PT2 can be expressed as 384×T and 128×T, respectively.

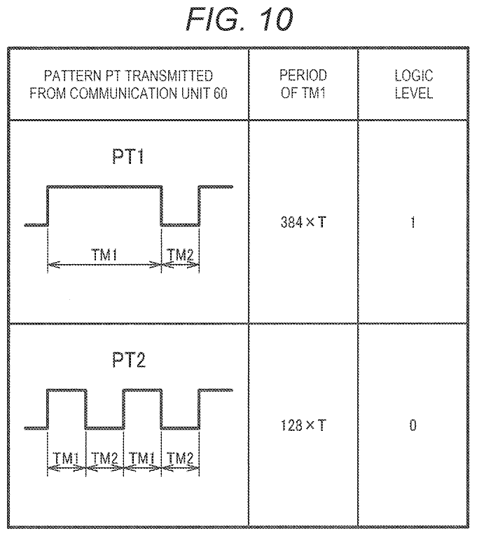

FIG. 10 is a table summarizing a correspondence relationship among the waveform pattern PT, the length of the period TM1 in the first load state, and the logic level described above. In this way, by defining the waveform patterns and assigning the logic level to each waveform pattern, it is possible to eliminate a situation in which the communication data is erroneously read due to the noise included in the signal.

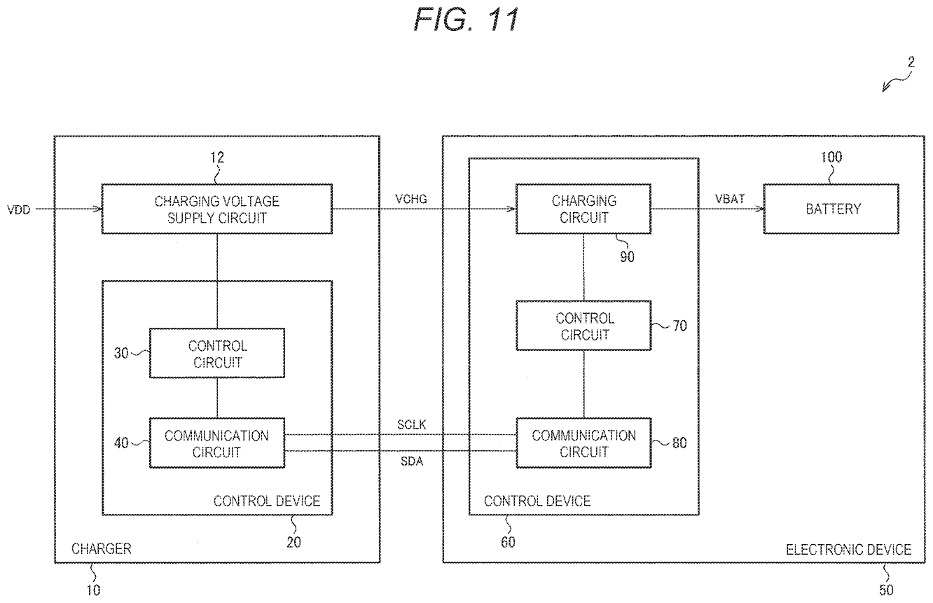

FIG. 11 shows a first modification of the present embodiment. The first modification differs from the configuration example in FIG. 3 in a communication method between the charger 10 and the electronic device 50. In the first modification, the communication method is implemented not by the load modulation but by serial communication such as inter-integrated circuit (I2C). Specifically, in FIG. 11, the communication circuit 80 of the electronic device 50 and the communication circuit 40 of the charger 10 are electrically coupled to each other via two wirings. One wiring corresponds to a serial clock SCLK, and the other wiring corresponds to serial data SDA. In FIG. 11, the communication data such as the battery voltage information is communicated from the electronic device 50 to the charger 10 through the serial communication such as I2C. In addition, the serial communication is not limited to the serial communication by I2C, and may be serial communication by a serial peripheral interface (SPI), for example.

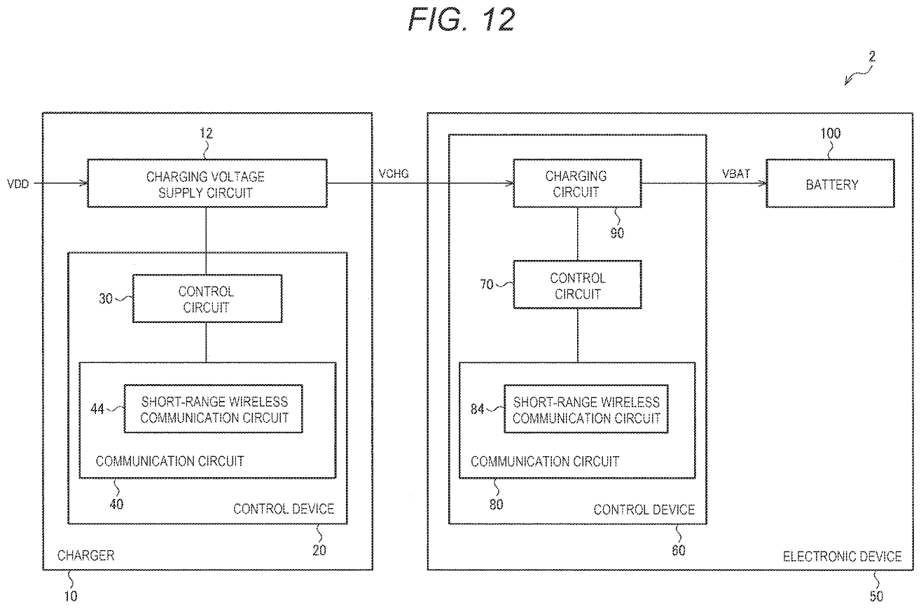

FIG. 12 shows a second modification of the present embodiment. The second modification also differs from the configuration example in FIG. 3 in the communication method between the charger 10 and the electronic device 50. In the second modification, the communication method is implemented not by the load modulation but by short-range wireless communication. The second modification is different from the detailed configuration example in FIG. 3 in configurations of the control circuit 30, the communication circuit 40, and the control device 60. Specifically, the communication circuit 40 of the charger 10 includes a short-range wireless communication circuit 44, and the communication circuit 80 of the electronic device also includes a short-range wireless communication circuit 84. The communication data such as the battery voltage information is communicated by short-range wireless communication between the communication circuit 40 and the communication circuit 80. As the short-range wireless communication, Bluetooth (registered trademark) such as Bluetooth low energy (BLE) can be used, for example. Alternatively, as the short-range wireless communication, ZigBee (registered trademark), Wi-SUN (registered trademark), IP 500 (registered trademark), or the like may be used.

### 3. Processing Example

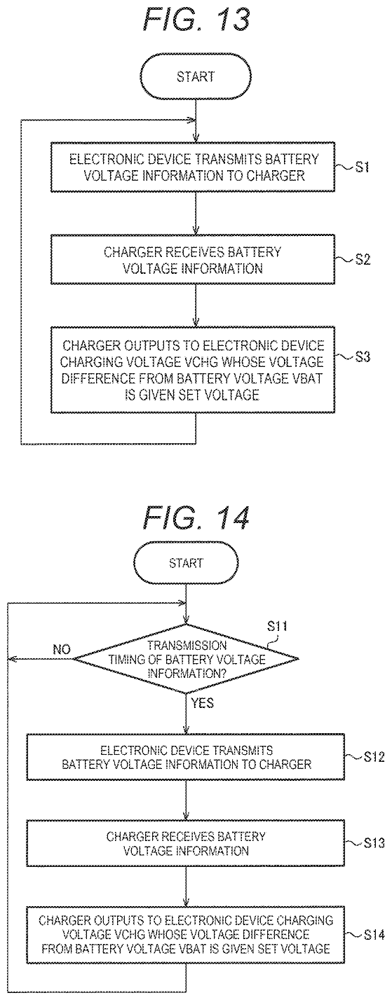

FIG. 13 is a flowchart illustrating an example of a communication process according to the present embodiment. A flow of the communication process shown in FIG. 13 assumes a communication process in a basic configuration example of the charging system 2 in FIG. 1. First, the electronic device 50 transmits battery voltage information to the charger 10 (step S1). Next, the charger 10 receives the battery voltage information (step S2). Then, the charger 10 outputs to the electronic device 50 the charging voltage VCHG whose voltage difference from the battery voltage VBAT is a given set voltage (step S3). The battery voltage information is as described above.

As described above, as shown in FIG. 1, the charging system 2 according to the present embodiment is a contact type charging system including the electronic device and the charger 10. Then, as shown in FIG. 13, the electronic device 50 transmits the battery voltage information of the battery 100 of the electronic device 50 to the charger 10. Then, the charger 10 outputs the charging voltage VCHG based on the battery voltage information such that the voltage difference between the charging voltage VCHG of the battery 100 and the battery voltage VBAT of the battery 100 is a given set voltage. That is, the charging system 2 according to the present embodiment is a contact type charging system 2 including the electronic device 50 and the charger 10, in which the electronic device 50 transmits the battery voltage information of the battery 100 of the electronic device 50 to the charger 10, and the charger 10 outputs the charging voltage VCHG based on the battery voltage information such that the voltage difference between the charging voltage VCHG of the battery 100 and the battery voltage VBAT of the battery 100 is a given set voltage.

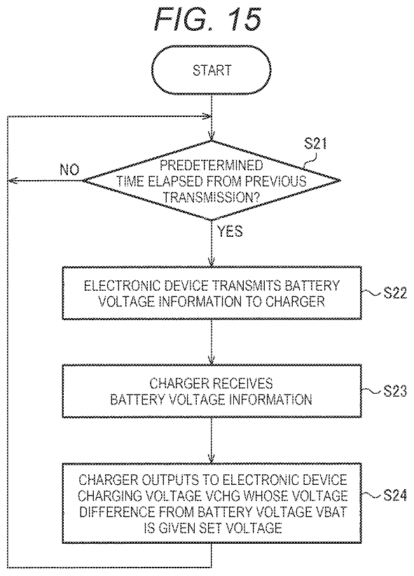

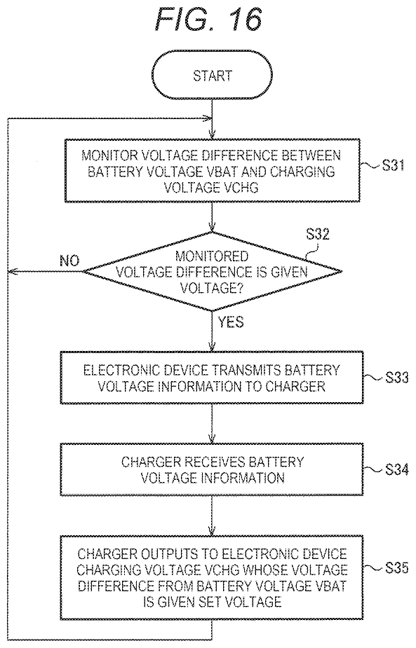

FIG. 14 is a flowchart illustrating a first detailed example of the communication process according to the present embodiment. FIG. 14 differs from FIG. 13 in that step S11 of determining whether there is a transmission timing of the battery voltage information is provided before step S12 corresponding to step S1 in FIG. 13. As described above, in order to charge the battery 100 while limiting an increase in temperature of the electronic device 50, it is desirable to control the voltage difference between the charging voltage VCHG and the battery voltage VBAT to be a given set voltage. Here, step S11 is provided as a step of performing a determination process necessary for performing the control. As a method for determining whether there is a transmission timing of the battery voltage information, various aspects other than cases in FIGS. 15 and 16 described later may be considered.

FIG. 15 is a flowchart illustrating a second detailed example of the communication process according to the present embodiment. In FIG. 15, a process in step S21 is provided as the process in step S11 in FIG. 14. Specifically, the step (step S11) of determining the transmission timing of the battery voltage information in FIG. 14 is a method for determining the transmission timing depending on whether a predetermined time has elapsed from a previous transmission timing in step 21 in FIG. 15. As described above, when the battery 100 of the electronic device 50 is charged by the CC charging, it is desirable to control the voltage difference between the charging voltage VCHG and the battery voltage VBAT to be a given set voltage in order to reduce the heat generation in the electronic device 50 while securing the constant current. As a control method therefor, as shown in steps S21 and S22 in FIG. 15, there is a method for periodically transmitting the battery voltage information to the charger 10 in the electronic device 50.

That is, the communication process shown in FIG. 13 may be a communication process in which the electronic device 50 includes the load modulation circuit 82 and transmits the battery voltage information to the charger 10 by the load modulation with the load modulation circuit 82. In addition, in the communication processes shown in FIGS. 13 and 14, the electronic device 50 periodically transmits the battery voltage information to the charger 10.

In this way, it is easy to determine whether there is a timing for transmitting the battery voltage information in the electronic device 50. Also in the charger 10, the charging voltage VCHG to which a given set voltage is added to the battery voltage VBAT may be output based on the transmitted battery voltage information, and the communication process is simplified. The communication process in FIG. 15 is effective, for example, when a speed of increase of the battery voltage VBAT is within a certain range with respect to the charging voltage VCHG.

FIG. 16 is a flowchart illustrating a third detailed example of the communication process according to the present embodiment. In FIG. 16, processes shown in steps S31 and S32 are performed as the process in step S11 in FIG. 14. Specifically, the electronic device 50 monitors the voltage difference between the charging voltage VCHG and the battery voltage VBAT or the battery voltage VBAT (step S31), determines whether the monitored voltage difference is a given set voltage, and determines the transmission timing (step S32). Here, when the voltage difference is smaller than the given set voltage (YES), the battery voltage information is transmitted to the charger 10, and when the voltage difference maintains the given set voltage (NO), the process returns to step 31. As a method for controlling the voltage difference between the charging voltage VCHG and the battery voltage VBAT to be the given set voltage, it is monitored whether the charging voltage VCHG is lower than VBAT+ΔV in the electronic device 50, and when VCHG is lower than VBAT+ΔV, the battery voltage information is transmitted to the charger 10 for the first time, and a value of the charging voltage VCHG is changed.

That is, in the communication process shown in FIG. 16, in FIGS. 13 and 14, the electronic device 50 monitors the voltage difference between the charging voltage VCHG and the battery voltage VBAT or the battery voltage VBAT, and determines the transmission timing of the battery voltage information based on a monitoring result.

According to the third detailed example of the communication process in FIG. 16, a load of the communication processes of the charger 10 and the electronic device 50 is reduced as compared with the second detailed example in FIG. 15 in which the battery voltage information is periodically transmitted regardless of whether VCHG is lower than VBAT+ΔV. The communication process in FIG. 16 is effective, for example, when the speed of increase of the battery voltage VBAT is not constant with respect to the charging voltage VCHG.

As described above, the control device according to the present embodiment relates to a control device including a communication circuit configured to acquire battery voltage information of a battery of an electronic device, and a control circuit configured to control, based on the battery voltage information, a charging voltage supply circuit that supplies a charging voltage to the electronic device at a contact point such that a voltage difference between the charging voltage and a battery voltage of the battery is a given set voltage.

According to the present embodiment, it is possible to charge the battery of the electronic device by setting a charging voltage capable of achieving both securement of a current necessary for charging the battery and avoidance of a problem in the circuit operation associated with an increase in temperature inside the electronic device due to the charging.

In addition, in the control device according to the present embodiment, the battery voltage information may be a battery voltage.

In this way, it is possible to set an optimum charging voltage for avoiding the heat generation in the electronic device while securing a current with respect to the battery voltage at a current time on a charger side.

In addition, in the control device according to the present embodiment, the battery voltage information may be voltage difference information between the battery voltage and the charging voltage.

In this way, it is possible to facilitate the control process of the charging voltage on the charger side.

In addition, in the control device according to the present embodiment, the control circuit on the electronic device side may include a register configured to set the set voltage.

In this way, information on the set voltage corresponding to the amount of the heat generation allowed in the electronic device can be stored in the register, and the charging voltage can be set to a desired voltage based on the information.

In addition, in the control device according to the present embodiment, the communication circuit of the charger may include a current detection circuit configured to detect a current flowing through a power supply line of the charging voltage supply circuit.

In this way, the battery voltage information transmitted by the electronic device can be acquired by detecting the current flowing through the power supply line of the charging voltage supply circuit.

Another aspect of the present disclosure relates to a contact type charging system including an electronic device and a charger. The electronic device is configured to transmit battery voltage information of a battery of the electronic device to the charger, and the charger is configured to output a charging voltage of the battery based on the battery voltage information such that a voltage difference between the charging voltage and a battery voltage of the battery is a given set voltage.

For example, in charging the battery, since there is a problem of an increase in temperature of the electronic device due to a surplus charging voltage and a problem in the circuit operation associated with the increase in temperature, it is desirable to monitor the battery voltage and output the optimum charging voltage to the electronic device side. Therefore, according to the present embodiment, the information on the battery voltage acquired on the electronic device side can be received on the charger side, and the charger can output the optimum charging voltage based on the information.

In addition, in the charging system according to the present embodiment, the electronic device may include a load modulation circuit, and may be configured to transmit the battery voltage information to the charger by load modulation with the load modulation circuit.

In this way, the data communication between the charger and the electronic device can be implemented on the wiring used for the electric power supply, and it is not necessary to provide a wiring separately from the wiring used for power supply.

In addition, in the charging system according to the present embodiment, the electronic device may periodically transmit the battery voltage information to the charger.

In this way, it is easy to determine whether there is a timing for transmitting the battery voltage information in the electronic device.

In addition, in the charging system according to the present embodiment, the electronic device may be configured to monitor the voltage difference between the charging voltage and the battery voltage or the battery voltage, and determine a transmission timing of the battery voltage information based on a monitoring result.

In this way, the load of the communication process of the charger is reduced as compared with the case where the battery voltage information is periodically transmitted regardless of a value of the battery voltage.

Further, yet another aspect of the present disclosure relates to a control device including a charging circuit configured to charge a battery based on a charging voltage supplied from a charger at a contact point, a communication circuit configured to transmit a battery voltage of the battery to the charger, and a control circuit configured to control the communication circuit and the charging circuit. The control circuit is configured to monitor a voltage difference between the charging voltage and the battery voltage or the battery voltage, and determine a transmission timing of battery voltage information based on a monitoring result.

According to the present embodiment, it is possible to charge the battery of the electronic device while avoiding the problem in the circuit operation associated with the increase in temperature of the electronic device or the like in the charging system.

Although the present embodiment has been described in detail as described above, it will be readily apparent to those skilled in the art that many modifications may be made without departing substantially from novel matters and effects of the present disclosure. Therefore, all such modifications are intended to be included within the scope of the present disclosure. For example, a term cited with a different term having a broader meaning or the same meaning at least once in the specification or in the drawings can be replaced with the different term in any place in the specification or in the drawings. In addition, all combinations of the present embodiment and the modifications are also included in the scope of the present disclosure. The configurations, operations, and the like of the control device, the charging system, the charger, and the electronic device are not limited to those described in the present embodiment, and various modifications can be made.

What is claimed is:

1. A control device comprising:
a communication circuit configured to acquire battery voltage information of a battery of an electronic device; and
a control circuit configured to control, based on the battery voltage information, a charging voltage supply circuit that supplies a charging voltage to the electronic device at a contact point such that a voltage difference between the charging voltage and a battery voltage of the battery is a given set voltage.

2. The control device according to claim 1, wherein
the battery voltage information is the battery voltage.

3. The control device according to claim 1, wherein
the battery voltage information is voltage difference information between the battery voltage and the charging voltage.

4. The control device according to claim 1, wherein
the control circuit includes a register configured to set the set voltage.

5. The control device according to claim 1, wherein
the communication circuit includes a current detection circuit configured to detect a current flowing through a power supply line of the charging voltage supply circuit.

6. A contact type charging system comprising:
an electronic device; and
a charger, wherein
the electronic device is configured to transmit battery voltage information of a battery of the electronic device to the charger, and
the charger is configured to output a charging voltage of the battery based on the battery voltage information such that a voltage difference between the charging voltage and a battery voltage of the battery is a given set voltage.

7. The charging system according to claim 6, wherein
the electronic device includes a load modulation circuit, and is configured to transmit the battery voltage information to the charger by load modulation with the load modulation circuit.

8. The charging system according to claim 6, wherein
the electronic device is configured to periodically transmit the battery voltage information to the charger.

9. The charging system according to claim 6, wherein
the electronic device is configured to monitor the voltage difference between the charging voltage and the battery voltage or the battery voltage, and determine a transmission timing of the battery voltage information based on a monitoring result.

10. A control device comprising:
a charging circuit configured to charge a battery based on a charging voltage supplied from a charger at a contact point;
a communication circuit configured to transmit a battery voltage of the battery to the charger; and
a control circuit configured to control the communication circuit and the charging circuit, wherein
the control circuit is configured to monitor a voltage difference between the charging voltage and the battery voltage or the battery voltage, and determine a transmission timing of battery voltage information based on a monitoring result.
